(19) United States
(12) Patent Application Publication
(10) Pub. No.: US 2021/0324572 A1
(43) Pub. Date: Oct. 21, 2021

(54) Detergent Dispensing Laundry Basket

(71) Applicant: Adam Rodriguez, Clovis, CA (US)

(72) Inventor: Adam Rodriguez, Clovis, CA (US)

(21) Appl. No.: 16/850,640

(22) Filed: Apr. 16, 2020

(51) Int. Cl. D06F 95/00; G07D 9/00

(52) U.S. Cl. CPC D06F 95/002; G07D 9/002

(57) ABSTRACT

An exemplary approach toward a washable, reusable detergent dispensing laundry basket with fixed reservoir tanks to store cleaning powder or liquid with push flow nozzles that allow detergent to be dispensed from reservoir tank and coin dispensing mechanism allowing users to have free hands while carrying soiled clothes, washing powder/liquid, coins and other similar articles.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever

### BACKGROUND

### Field of the Invention

The invention relates to an improved basket for containing laundry to be washed, and particularly to a laundry basket with enhanced feature of dispensing detergent and coins.

### Description of the Related Art

Laundry baskets are well known in the household for the purpose: of placing into wet laundry or washing taken from the sink or washing machine this then being carried from the house to the washing line outside. The basket is then placed on the ground while the individual items are removed and pegged onto the line.

This necessitates moving the basket along in the direction of the washing line from time to time as the line is being filled. The basket is used in a similar way when the dry laundry is being collected in.

A basket of wet laundry can be heavy and picking out items from ground level can be hard on the person's back; especially while holding a number of other items like detergents or coins in the hand. It would be convenient if the other necessary items could be stored near or in the laundry basket.

Most commonly used laundry baskets on the market only have the function of storing and carrying bulk clothes. However, there are multiple inventions that have been proposed in prior art regarding advancements in similar field. For instance, Laundry with an improved basket bearing French patent 2,694,026A1 is issued to Electrolux Zanussi Elettrodomestici SpA. The patent is on an invention relates to a washing machine with an improved basket. The top-loading washing machine, particularly for domestic use, comprising a tank and containing a perforated basket of cylindrical shape rotating about a horizontal axis and into which the articles to be washed are introduced, wherein the cylindrical strip (1) of the basket is at least partially made up of a plurality of cells (3), each of which is provided with at least one opening (4) facing outwards and from at least one opening (5) oriented towards the inside of the basket and wherein said cells (3) are arranged in a given order along adjacent rings on said strip, said cells being substantially adjacent. Said openings allow the liquid to pass inside the respective cells, during the phase during which they are immersed in the washing bath and they fall back on the load of laundry to be washed, when they reach a position high on said load.

Another patent on Easy-taking type laundry basket bearing Taiwan patent 4,852,28U is issued to qi-xiong Zhouguan-jin Wang. The patent is on an easy-to-use laundry basket, comprising: a lower frame, comprising a lower ring frame in the shape of a ring and a plurality of frame rods which are respectively connected to the inner side wall of the lower ring frame and are spaced apart from each other, and the plurality of frame rods are arranged Forming a plurality of small frame holes; the plurality of rods are annularly arranged on the lower ring frame at a spaced distance, so as to enclose an accommodation space above the lower frame, and the lower end of each of the rods is coupled to the lower ring a frame, wherein the rod body can form a swinging state and an upright fixed state on the lower ring frame; and an upper frame is in a loop shape and is disposed above the lower frame, the upper frame is available for the plurality The upper end of the rod body is swingably coupled; and a strap is attached to the opposite sides of the upper frame respectively.

A Laundry Hamper for insertion into Clothes Washers And Dryers bearing US patent 2,011,0094902A1 is issued to Tucker Patrick Delehey J. Molly Delehey P. Brent Delehey. The patent in one embodiment of a hamper for the insertion into conventional consumer and commercial clothing washers and dryers. The article is cylindrical shaped article to fit inside typical front load and top load commercial or consumer clothing washer and dryer. This embodiment of our hamper has cut out transport handles 2 in the side of the cylinder and handles in the top lip of the cylinder 3. In addition, the base 6 and cylinder sides contain the apertures 1 for liquid drainage during the washing cycle and ventilation during the drying cycle. The cylinder sides may contain recessed baffles 5 along the cylinder walls to fit over the baffles of existing front load washer and dryers or concavities originating in the base to fit over agitators of top load washers.

Another patent on Laundry basket with hip hugging feature bearing U.S. Pat. No. 7,677,408B2 is issued to Rubbermaid Inc. The patent is on a laundry basket has a bottom panel with a perimeter. A contiguous side wall extends generally upward from the perimeter of the bottom panel and terminates at an upper end. A basket interior is defined above the bottom panel and bounded by the side wall. A curved wall section of the side wall is curved concavely inward toward the basket interior. The bottom panel and the contiguous side wall, including the curved wall section, are formed of a primary material. A cushion pad is positioned generally at the upper end of the curved wall section and is formed from a secondary material that is softer than the primary material of the curved wall portion.

A U.S. Pat. No. 5,279,443A on Laundry basket and handle therefor is issued to ExxonMobil Oil Corp. The patent discusses a laundry basket and a handle assembly therefor are disclosed. The laundry basket includes a walled container having a peripheral rim about a substantial portion thereof, a pair of opposing hand openings adjacent the peripheral rim, and a pair of handle members extending, respectively, about the rim and through the hand openings, each of the handle members including a bottom portion positioned below the rim, the bottom portion defining an upper boundary of one of the hand openings and a top portion, the top portion being connected to the bottom portion, wherein one of the top or bottom portions of each of the handle members is integral to the peripheral rim. Each portion of the handle members preferably includes a curved exterior surface to facilitate the lifting and carrying of the basket.

A U.S. Pat. No. 4,948,077A on Laundry buggy is issued to Anthony J. Gonzalez. The patent discloses a laundry buggy is collapsible to a small space, such as that of a large attache case, and which is erectable into a basket assembly with a supporting leg structure. The laundry buggy includes a basket assembly and a leg assembly. The basket assembly comprises a bottom wall, a first end wall pivotally connected to an upper side of the bottom wall adjacent one end thereof, a second end wall pivotally connected to an upper side of the bottom wall adjacent the other end thereof, the end walls being pivotable towards each other and downwardly over the bottom wall to form a collapsed basket assembly and each having side edge, a piece of flexible material being fixed to and between each pair of opposed side edges of the end walls, and forming flexible side walls of the basket assembly and being collapsible to a position underneath the end walls when they are collapsed downwards. The leg assembly comprises first and second U-shaped leg formations each including a first leg that is pivotably connected to a second leg of the other formation and an upper bight-forming bar, first and second U-in-cross-section snap-type clamps fixed respectively to the underside of the bottom wall of the basket assembly adjacent each end thereof for snap-fittingly receiving the bight-forming bar of one of the leg formations for fixing the leg assembly in an upright erect position to the underside of basket assembly.

A U.S. Pat. No. 4,981,232A on Laundry basket is issued to Paul M. Wynn. The patent is on an improved laundry basket having a detachable divider wall that divides the laundry basket into a clothes compartment and a clothes washing products compartment. A top wall panel extends laterally from the top edge of the divider wall toward the closest side wall so that it spans the clothes washing products compartment, A lip on the outer edge of the top wall panel mates with the lip of the respective side wall. An aperture is formed in the top wall panel and it detachably receives a cup having an outwardly extending annular flange at its top edge. Raised indicia structure on the outer surface of the cup provides markings for measuring contents in the cup. With the divider panel removed, a plurality of laundry baskets may be stacked in a nested fashion.

There are multiple inventions that have been proposed in prior art regarding launder baskets and similar advancements. However, the utility of these systems has not been seen in advance form and for the above discussed needs. Moreover, most of the existing s systems implement stagnant and non-useful support techniques and therefore struggle to manage laundry items continues. Furthermore, the current solutions aren't able to handle large amount of clothing articles, detergent, pegs and coins.

Looking at prior art no invention has been found which can assist specifically consumers like senior citizens or mothers with young children. The current invention proposes a system which is the apparatus and method is based on unique feature of a laundry basket with self-contained detergent tanks that dispenses detergents and coins when user goes for laundry.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a hill description. A full appreciation of the various aspects of the invention can be gained by taking the entire specification, claims, drawings, and abstract as a whole.

It is therefore the purpose of the invention to alleviate at least to some extent one or more of the aforementioned problems of the prior art and/or to provide the relevant public with a suitable alternative thereto having relative advantages.

The primary object of the invention is related to a detergent dispensing laundry basket allowing hands to be free while carrying laundry basket.

It is another object of the invention to provide a novel improved laundry basket that has structure for holding coins to be used in coin operated washing and drying machines.

It is also the objective of the invention to provide an easy to fit assembly which can secure all the items in efficient manner and thus keeps the user who can be elderly, with special need or mothers with young children comfortable while doing the washing job.

A still further object of the present invention is to provide a laundry basket apparatus which is portable, or which can be permanently affixed to a floor or wall.

It is a further object of the invention to provide an improved novel laundry basket that is economical to manufacture and market.

It is furthermore the objective of the invention to provide user with aesthetic satisfaction by the beautiful and light weight design, which is easy to carry and manage.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 discloses the top view of basket and reservoir tank detached from its fixing point as per preferred embodiments of the invention.

FIG. 2 discloses another top view showing movement of reservoir tank as per preferred embodiments of the invention.

FIG. 3 discloses another view of movement of reservoir tank as per preferred embodiments of the invention.

FIG. 4 discloses the reservoir tanks touching the base of basket and will be fixed in its fixing spot later as per preferred embodiments of the invention.

FIG. 5 discloses the inner structural view of reservoir tanks in its moving and fixed form as per preferred embodiments of the invention.

FIG. 6 discloses internal movement of reservoir tank in laundry basket assembly as per preferred embodiments of the invention.

FIG. 7 discloses side view of laundry basket assembly as per preferred embodiments of the invention.

FIG. 8 discloses coin storing compartment of laundry basket assembly as per preferred embodiments of the invention.

FIG. 9 discloses coin storing dispensing mechanism of laundry basket assembly as per preferred embodiments of the invention.

FIG. 10 discloses each part of detergent dispensing laundry basket in its opened form as per preferred embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The current invention in its preferred embodiment discloses an advancement in a laundry basket which has separate compartments to hold and dispense detergent and coins for commercial washing and drying machines.

Presently a large percentage of our population lives in apartments and rental housing and do not have their own washing machines and clothes dryers. These people periodically take a load of dirty laundry to the commercial laundry for self-washing. In doing so they stack their laundry baskets full of dirty laundry, pile their boxes of detergent, fabric softener, bleach, etc. on top of the load and then struggle with a hand full of change. More often than desired, the person carrying the mountain of laundry and boxes manages to drop one or more items and while attempting to pick them up additional items manage to fall.

Applicant's novel improved laundry basket has been designed to solve many problems presently experienced by people who use commercial coin operated laundry facilities when washing their clothes. The basic structure of the laundry basket is preferably rectangular in shape and several of its side walls are formed of a lattice-like structure by intersecting vertical and horizontal strips of plastic material.

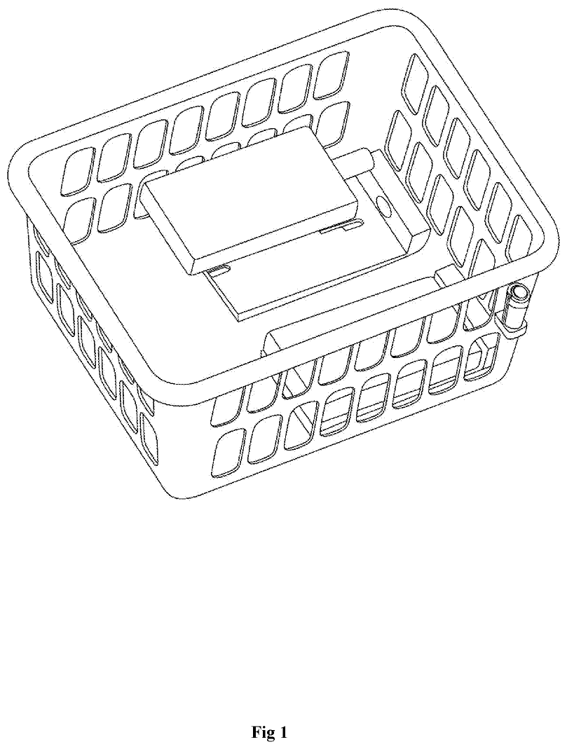

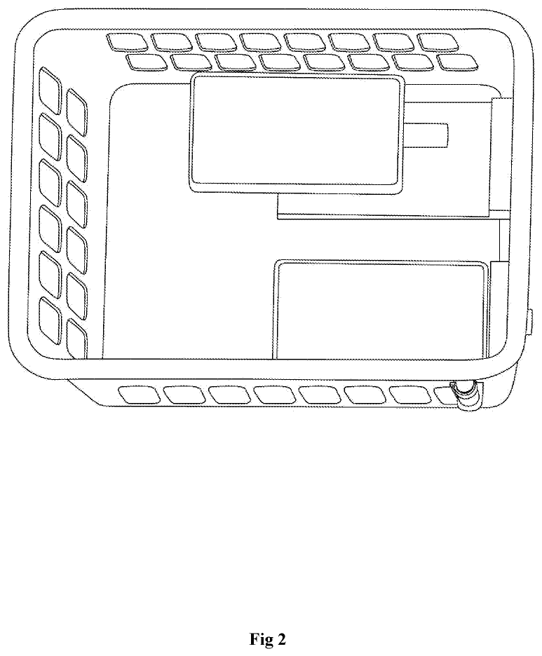

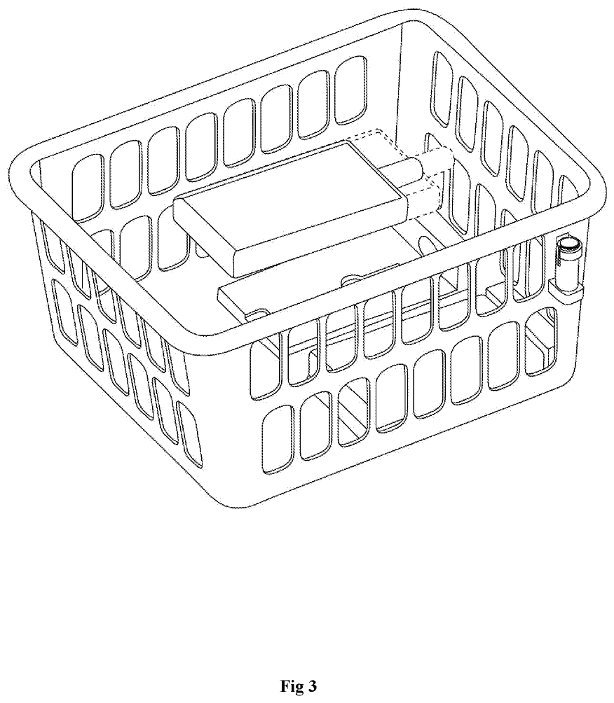

The laundry basket with detergent dispensing system is realized in order to attain the aim of the present invention is illustrated in the attached figures, where FIG. 1 discloses the top view of basket and reservoir tank detached from its fixing point as per preferred embodiments of the invention. The FIG. 2 discloses another top view showing movement of reservoir tank within the basket assembly. FIG. 3 discloses another view of movement of reservoir tank to support the refilling process.

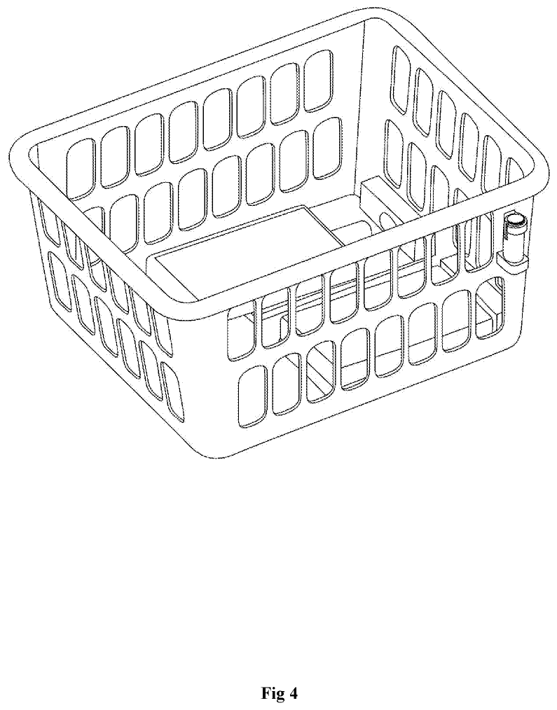

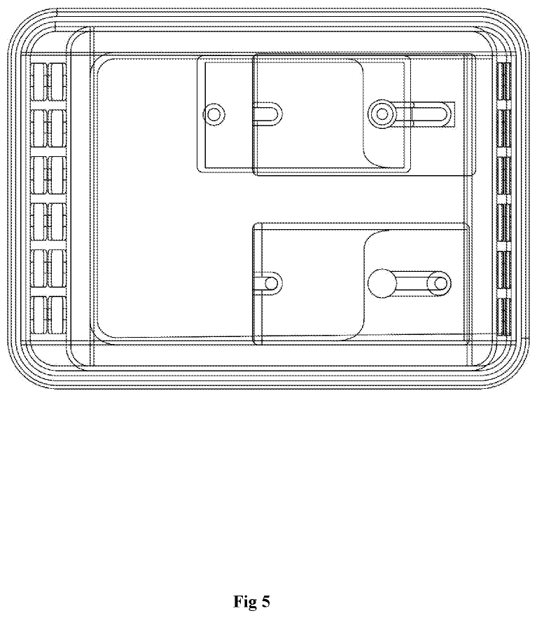

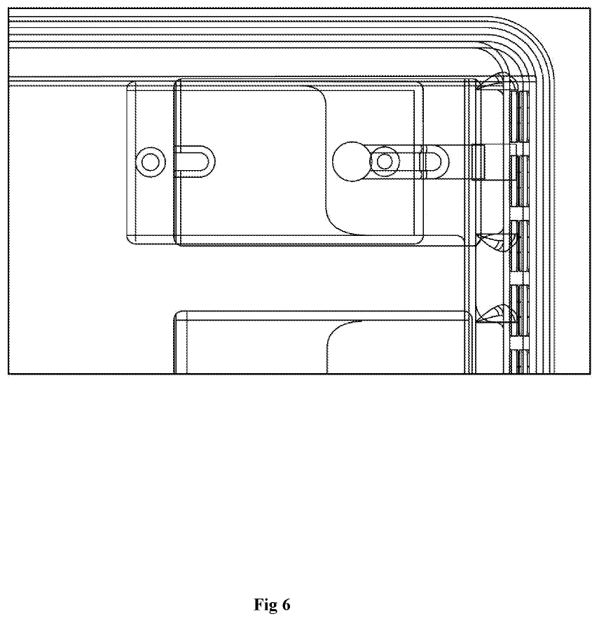

FIG. 4 discloses the reservoir tanks touching the base of basket and will be fixed in its fixing spot later as per preferred embodiments of the invention. FIG. 5 shows the inner structural view of reservoir tanks in its moving and fixed form, so that the liquid doesn't flow out of the reservoir tank. FIG. 6 furthermore shows the internal movement of reservoir tank in laundry basket.

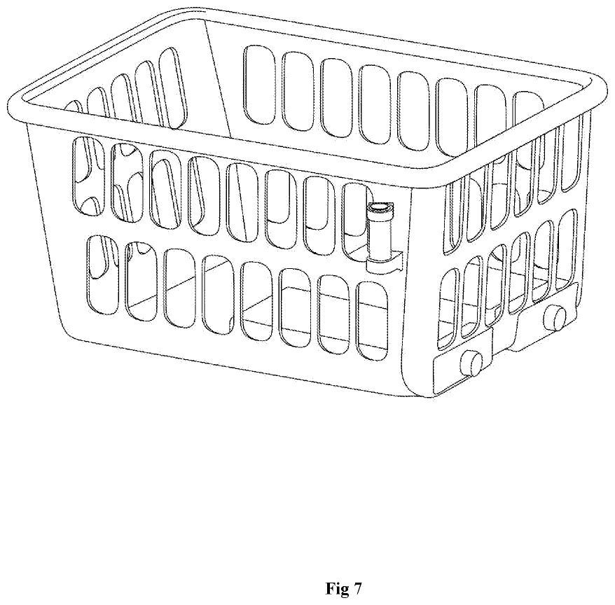

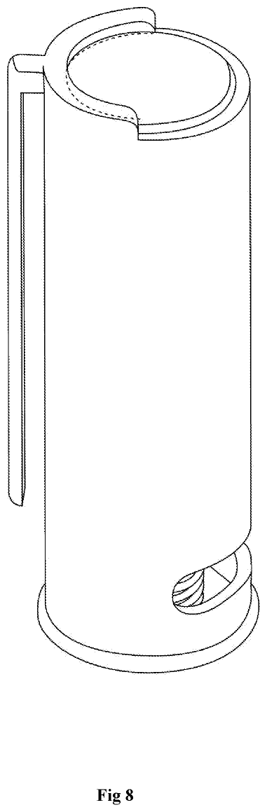

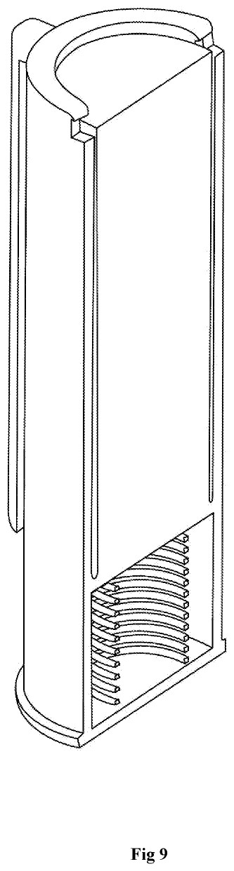

FIG. 7 shows the side view of laundry basket where laundry basket can be seen with its dual compartments for carrying the detergent or fabric softener. The coin dispenser at the outer side of laundry basket can also be seen. FIG. 8 further shows the coin storing compartment of laundry basket assembly and FIG. 9 discloses coin storing dispensing mechanism of laundry basket assembly as per preferred embodiments of the invention.

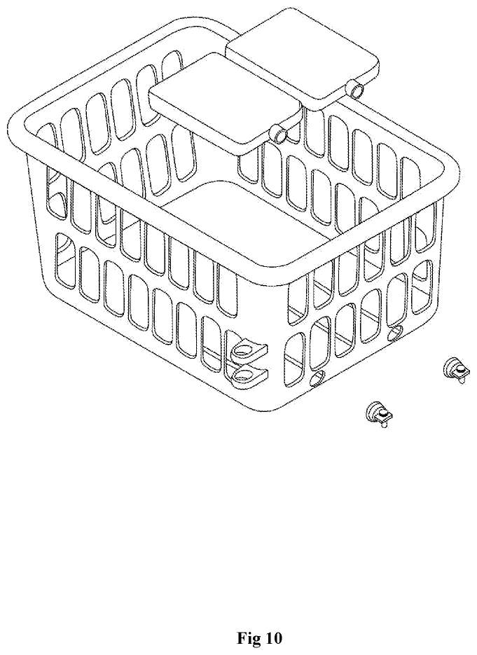

FIG. 10 discloses each part of detergent dispensing laundry basket in its opened where the reservoir tanks and caps can be seen.

The basket has divider compartments divides the interior of the laundry basket into clothes section and clothes washing products compartment. Some items that might be stored in the clothes washing compartment are detergents, fabric softeners, bleach, etc. The interior compartment is formed of a planar sheet of material and the other surrounding walls compartment are preferably formed with a solid sheet of material.

The basket also has a compartment to store coins. It has structure for holding coins to be used in coin operated washing and drying machines. The holding aperture is formed on the outer area of the top wall panel and can detachably receive coins. It can be used to carry coins when carrying the dirty laundry to the coin operated laundry machines.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

I: The present invention discloses a detergent dispensing basket comprising:
an elongated bottom wall having a predetermined length, said bottom wall having a front edge, a rear edge and laterally spaced side edges;
reservoir tanks preferably made of plastic and other similar material to store detergents, fabric softeners, bleach and other similar materials;
reservoir tanks having push flow nozzles allowing liquid to be dispensed from reservoir tanks and
a fixed currency coin dispensing mechanism to hold and dispense coins.

II: The laundry basket with detergent dispensing where:
A laundry basket as recited in claim 1 wherein said laundry basket is integrally formed of plastic material;
A laundry basket as recited in claim 1 wherein said top wall panel has an aperture in it for receiving and supporting a holder for coins;
A laundry basket as recited in claim 1 wherein said laundry basket has a rectangular shape;
A laundry basket as recited in claim 1 wherein the outer surface of said cup has a push flow nozzle allowing liquid to be dispensed from reservoir tanks and
plurality of raised indicia structure on it that functions as measuring marks for reservoir tank.
